(19) United States
(12) Patent Application Publication
(10) Pub. No.: US 2025/0376597 A1
(43) Pub. Date: Dec. 11, 2025

(54) POLYSILOXANE BASED INTUMESCENT COATING COMPOSITION

(71) Applicant: HEMPEL A/S, Kongens Lyngby (DK)

(72) Inventor: Omar Brun CUBERO, Kongens Lyngby (DK)

(21) Appl. No.: 18/876,801

(22) PCT Filed: Jun. 26, 2023
(86) PCT No.: PCT/EP2023/067341

§ 371 Date: Dec. 19, 2024

(30) Foreign Application Priority Data
Jun. 27, 2022 (EP) 22382600.9

(51) Int. Cl. C09D 5/18; C08G 59/24; C08G 59/32; C08G 59/38; C08G 59/50; C09D 163/00

(52) U.S. Cl. CPC C09D 5/185; C08G 59/245; C08G 59/3281; C08G 59/38; C08G 59/504; C09D 163/00

(57) ABSTRACT

A polysiloxane based intumescent coating composition includes a) a polysiloxane based binder system having i) one or more epoxy-functional polysiloxane; and b) one or more catalyst. Said a) polysiloxane based binder system may further comprise ii) one or more amino-functional polysiloxane. The coating composition is used for application on a substrate's surface. A substrate may be a steel substrate having on the surface a coat obtained from the coating composition of the invention. A kit of parts is for preparation of a polysiloxane based intumescent coating composition.

### FIELD OF THE INVENTION

The present invention relates to a new polysiloxane based intumescent coating composition. The invention further relates to the use of the coating composition of the invention for application on the surface of a substrate. The invention also relates to a substrate, preferably a steel substrate, having on the surface a coat obtained from the coating composition of the invention. The invention also relates to a kit of parts for preparation of a polysiloxane based intumescent coating composition.

### BACKGROUND OF THE INVENTION

The present invention relates to an intumescent coating composition and its use to protect structures, and substrates coated with said composition.

Many materials, such as steel, rapidly lose their strength and fail in a fire. Structural collapse of “high-rise” office blocks, oil and gas facilities or other infrastructure, and process vessel or pipework rupture as a result of a fire can be catastrophic in terms of escalation of the incident, damage to property, and even loss of life.

Buildings having steel frameworks are particularly vulnerable to collapse in the event of a fire. Steel loses its strength as the temperature rises. By providing an intumescent coating onto the steel, the rate of heat transfer can be reduced, which can extend the time the building remains intact, giving more time for evacuation.

Various intumescent coatings for protecting substrates against damage by fire are described in “Fire-Protective and Flame-Retardant Coatings—A State-of-the-Art Review” by E. D. Weil in Journal of Fire Sciences (2011), 29(3): 259-296. Intumescent coatings are used on many structures to delay the effects of a fire. The coating slows the rate of temperature increase of the substrate to which the coating is applied and increases the time before the structure fails due to the heat of fire. The extra time makes it more likely that fire fighters will be able to extinguish the fire or at least apply cooling water before the structure fails. An intumescent coating acts by expanding or swelling when exposed to heat, thereby substantially extending the time before the substrate is damaged by the fire.

Intumescent coating compositions per se comprise intumescent components including components selected from acid-generating compounds, expansion agents and a carbon source (which may be comprised in the binder system or may be an added compound).

When intumescent coatings are exposed to fire or heat, and the temperature of the coating exceeds for example 200° C., the acid generating compound decomposes to provide an acid, and a carbon source reacts with the acid to form a carbonaceous char. The expansion agent likewise decomposes at elevated temperatures (e.g., greater than 200° C.) and produces additional gas that volumetrically expands the carbonaceous char and produces a carbonaceous foam.

Intumescent coating compositions may comprise one-component or two-component binder systems. Typical intumescent coating compositions are based on epoxy based binder systems, see for example WO 2021/250211. Various other binder systems may be used for intumescent coating compositions, e.g. WO 2010/131037 discloses intumescent coating compositions based on binder systems with silane-terminated polyurethanes or silane-terminated ethers; and US 2020/157361 discloses binders based on polymers carrying alkoxysilane groups. Intumescent coating compositions based on binder systems including polysiloxane are also known in the art. For example WO 2005/078012 and WO 2010/054984 discloses intumescent coating compositions comprising polysiloxane in combination with organic resins.

### SUMMARY OF THE INVENTION

The present invention provides a new polysiloxane based intumescent coating composition providing a coat with the combined properties of excellent fire protection and a good hardness development.

Accordingly, the present invention relates to an intumescent coating composition comprising
a) a polysiloxane based binder system comprising
   i) one or more epoxy-functional polysiloxane; and
b) one or more catalyst.

The binder system a) may further comprise
ii) one or more amino-functional polysiloxane.

In one aspect, the invention relates to a kit of parts, suitable for the formulation of an intumescent coating composition comprising a polysiloxane based binder system, wherein said kit comprises
A) a container containing one or more epoxy-functional polysiloxane; and
B) a container containing one or more catalyst.

In one aspect, the invention relates to a kit of parts, suitable for the formulation of an intumescent coating composition comprising a polysiloxane based binder system, wherein said kit comprises
A1) a container containing one or more epoxy-functional polysiloxane; and
A2) a container containing one or more amino-functional polysiloxane; and
wherein
   said container A1) further contains one or more catalyst, and/or
   said container A2) further contains one or more catalyst, and/or
   said kit further comprises B) a container containing one or more catalyst.

In one aspect, the invention relates to the use of an intumescent coating composition according to the invention for application on the surface of a substrate such as a metal substrate.

In one aspect, the invention relates to a substrate, preferably a metal substrate or metal alloy substrate such as a steel substrate having on at least a part of the surface, a coat obtained from a coating composition according to the invention.

### DETAILED DESCRIPTION OF THE INVENTION

The present invention relates to a new intumescent coating composition suitable for application on many different surfaces providing a coat with excellent fire protection and a very good hardness development over a relatively short curing time.

Preferably the intumescent coating composition is a liquid, ambient temperature curable coating composition, i.e. a liquid coating composition that is capable of being cured in ambient conditions/temperature, e.g. from −5 to 50° such as from 5 to 40° degrees Celsius at 50% relative humidity.

The intumescent coating composition comprises a binder system, one or more catalyst, an intumescent package and may further comprise fibers as well as “conventional” coating additives, fillers, pigments and solvents. The intumescent coating composition of the present invention is a polysiloxane based coating composition meaning that the binder system comprises more than 50 wt % of polysiloxanes, such as more than 55 wt %, such as more than 60 wt % or more than 65 wt %, preferably more than 70 wt % such as more than 75 wt % or 80 wt % or 85 wt % or 90 wt % or 95 wt % of polysiloxanes based on the weight of the total binder system, such as about 100 wt % of polysiloxanes based on the weight of the total binder system. In the context of the invention, said polysiloxane based binder system comprises one or more epoxy-functional polysiloxane and optionally one or more amino-functional polysiloxane.

Accordingly, the invention relates to an intumescent coating composition comprising a binder system comprising one or more epoxy-functional polysiloxane. In one embodiment, the binder system further comprises one or more amino-functional polysiloxane. It should be understood that when only an epoxy-functional polysiloxane is present, the curing will proceed through homopolymerisation of the epoxy groups, while when an amino-functional polysiloxane is present, crosslinking will occur between the amino-functional polysiloxane and the epoxy-functional polysiloxane while there may also be a certain degree of homopolymerisation between the epoxy-functional polysiloxane.

The claimed intumescent coating composition provides a coat with a very efficient fire protection. The inventors have found that the general time to failure measured at 550° C. is in the range of 75-150 minutes.

Comparative coats obtained from compositions with 100% organic epoxy binder only protects from fire in a period of only 45-65 minutes (comparative coats A, B, C and D in table 6).

The substrate to be coated may be composed of a single material such as for example metal or a metal alloy, preferably steel or iron. The substrate may also be composed of a combination of materials

The claimed intumescent coating composition may be useful for various types of fire protection including for example cellulosic fire protection, hydrocarbon fire protection, cryogenic fire protection, jet fire protection, pool fire protection and hydrogen fire protection. In one embodiment, said intumescent coating composition is for cellulosic fire protection and/or hydrocarbon fire protection. In one embodiment said intumescent coating composition is for both cellulosic and hydrocarbon fire protection.

The claimed intumescent coating compositions can be used to coat substrates such as a steel substrate intended to form building frameworks either off-site (during the steel preparation process) or on-site (after the steel framework has been laid in place at the site of the building).

The term “coating composition” indicates the mixed liquid composition comprising all constituents, ready to be applied on a substrate.

When used herein, the term “coat” indicates a coat obtained by applying a coating composition to a surface and allowing the composition to cure (may also be denoted “a cured coat”).

A coat may be obtained from application of one or more layers of a coating composition to obtain the desired thickness of the cured coat.

In one embodiment, the intumescent coating composition comprises
a) a polysiloxane based binder system comprising
   i) one or more epoxy-functional polysiloxane; and
b) one or more catalyst.

In a further embodiment, said a) polysiloxane based binder system further comprises
ii) one or more amino-functional polysiloxane.

In a further embodiment, the intumescent coating composition further comprises
c) an intumescent package.

In one embodiment, the intumescent coating composition comprises
a) a polysiloxane based binder system comprising
   i) one or more epoxy-functional polysiloxane; and
   ii) one or more amino-functional polysiloxane; and
b) one or more catalyst.

In a further embodiment, said coating composition further comprises c) an intumescent package.

In one embodiment, the intumescent coating composition comprises
a) a polysiloxane based binder system comprising
   i) one or more epoxy-functional polysiloxane; and
b) one or more catalyst; and
c) an intumescent package.

In one embodiment, the intumescent coating composition comprises
a) a polysiloxane based binder system comprising
   i) one or more epoxy-functional polysiloxane; and
   ii) one or more amino-functional polysiloxane; and
b) one or more catalyst; and
c) an intumescent package.

The polysiloxane based binder system in the intumescent coating composition according to the invention, comprises more than 50 wt % of polysiloxanes, such as more than 55 wt %, such as more than 60 wt % or 60 wt %, preferably more than 70 wt % such as more than 75 wt % or 80 wt % or 85 wt % or 90 wt % or 95 wt % of polysiloxanes based on the weight of the total binder system, such as about 100 wt % of polysiloxanes based on the weight of the total binder system.

### Binder System

The term “binder system” of the coating composition means the components in the coating composition being able to polymerise to form a binder matrix upon curing. As mentioned above, the polysiloxane based binder system in the claimed coating composition comprises one or more epoxy-functional polysiloxane and may optionally comprise one or more amino-functional polysiloxane.

The term “polysiloxane” is known in the art and is defined as a polymer with a repeating silicone-oxygen backbone (Si-0)ₙ in which each Si atom is substituted with two organic groups. Typically the organic substituents on each Si atom are the same, and may e.g. be selected from alkyl (e.g. methyl or ethyl) or phenyl groups. A particular typical polysiloxane is polydimethylsiloxane (PDMS). In the context of the invention both linear and branched polysiloxanes are included. Preferred mention is made of linear polysiloxanes.

The terms “epoxy-functional polysiloxane” and “amino-functional polysiloxane” are frequently used terms in connection with polysiloxane chemistry. “Epoxy-functional polysiloxane” refers to a polysiloxane with at least one reactive epoxy-functional group attached through a carbon linkage (i.e. not directly on an Si atom) in a terminal and/or pendant position while “amino-functional polysiloxane” refers to a polysiloxane with at least one reactive amine attached in a terminal and/or pendant position through a carbon linkage. Said amine is selected from primary and secondary amines. In the context of the invention, there must be at least one primary amino-functional group, or at least two secondary amino-functional groups, or at least one primary and at least one secondary amino-functional group.

The inventors have found that both when the intumescent coat is obtained solely by epoxy-epoxy homopolymerisation and when it includes amine groups the fire protection performance is excellent (Tables 1, 2 and 3). However, the hardness development is improved when amino-functional polysiloxane is present in the coating composition allowing crosslinking between epoxy groups and active hydrogens of the amine groups. Thus, the stoichiometry between active hydrogens of the amino groups relative to the epoxy groups may be adjusted to obtain a better hardness development. Thus, in one embodiment, the binder system comprises epoxy-functional polysiloxane and amino-functional polysiloxane in an amount such that the stoichiometry between active hydrogens of the amine group relative to epoxy groups is at least 5%, preferably at least 10%, more preferably at least 15%, such as at least 20%, such as at least 25%, such as at least 30, 40, 50, 60, 70, 80, 90, such as about 100%.

The stoichiometry between active hydrogens of the amino groups and the epoxy groups is described as the ratio of active hydrogens on the amino groups relative to epoxy groups, expressed as a percentage. It can be calculated by dividing the total number of active hydrogens by the total number of epoxy groups, and multiplying this value by 100. Thus, for example 50% stoichiometry means that the number of active hydrogens corresponds to 50% of the number of epoxy groups. Primary amines contain two active hydrogens, secondary amines contain one active hydrogen, and tertiary amines contain no active hydrogens.

The intumescent coating composition may be prepared from a range of different combinations of epoxy-functional polysiloxanes. When one or more amino-functional polysiloxane is present, the coating composition may be prepared from a range of different combinations of epoxy-functional and amino-functional polysiloxanes.

If any alkoxy groups are present on the epoxy-functional polysiloxane backbone and/or amino-functional polysiloxane backbone, said alkoxy groups are preferably present in an equivalent ratio of alkoxy groups to epoxy groups of 0:100 to 5:100. In a preferred embodiment, said epoxy-functional polysiloxane and/or said amino-functional polysiloxane do not have any alkoxy groups attached to the polysiloxane backbone. In one embodiment, both the epoxy-functional polysiloxane the amino-functional polysiloxane do not have any alkoxy groups attached to the polysiloxane backbone.

In one embodiment, said epoxy-functional polysiloxane does not have any condensable or hydrolysable groups attached to the polysiloxane backbone.

In a preferred embodiment, said epoxy-functional polysiloxane and/or said amino-functional polysiloxane do not have any reactive groups other than said epoxy-functional and amino-functional groups. In a further embodiment, both the epoxy-functional polysiloxane and the amino-functional polysiloxane do not have any reactive groups other than said epoxy-functional and amino-functional groups.

### Epoxy-Functional Polysiloxane

The term “epoxy-functional polysiloxane” is to be understood in the conventional sense and refers to a polysiloxane with at least one epoxy-functional group attached in a terminal and/or pendant position through a carbon linkage.

The epoxy-functionalities may, e.g. be introduced to the polysiloxane by means of an epoxysilane or by means of an epoxy resin, see e. g. EP 1 086 974 A. In one example hereof, the epoxy-functional polysiloxane is prepared by the reaction between an epoxy resin and a reactive polysiloxane, optionally by the concurrent action of further constituents such as constituents having hydroxyl and/or alkoxy groups, etc. In another example, the epoxy-functional polysiloxane may be prepared by subjecting an epoxysilane and an alkoxysilane mixture to partial hydrolysis and condensation. It should be understood that the epoxy-functional polysiloxane may be prepared in situ if desirable.

To obtain homopolymerisation of epoxy groups, one epoxy-functional group on each polysiloxane may be sufficient, while crosslinking with amino-functional polysiloxane requires the presence of polysiloxanes with at least two epoxy-functional groups. Thus, in one embodiment, said one or more epoxy-functional polysiloxane has at least one epoxy-functional group. In a further embodiment, said one or more epoxy-functional polysiloxane has at least two epoxy-functional groups. In a further embodiment, said binder system comprises i) one or more epoxy-functional polysiloxane; and ii) one or more amino-functional polysiloxane; wherein said one or more epoxy-functional polysiloxane has at least two epoxy-functional groups

In one embodiment, the epoxy-functional polysiloxane is represented by formula (I) below having a molecular weight in the range of 200 to 500,000 g/mol:

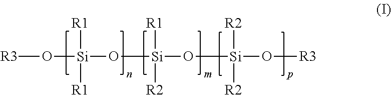

wherein n+m+p is an integer from 2 to 7500; and
wherein each R1 is individually selected from linear or branched C₁-C₃₀ alkyl, linear or branched C₂-C₃₀ alkenyl, C₃-C₃₀ cycloalkyl and aryl; and
wherein each R2 is individually selected from linear or branched C₁-C₃₀ alkyl, linear or branched C₂-C₃₀ alkenyl, C₃-C₃₀ cycloalkyl and aryl, substituted with at least one epoxy-functional group; and
wherein each R3 is individually selected from Si(R1)₃ or Si(R1)₂R2 or Si(R1)(R2)₂ or Si(R2)₃;
with the proviso that said epoxy-functional polysiloxane has at least one epoxy-functional group.

In one embodiment, said epoxy-functional polysiloxane has at least two epoxy-functional groups.

In one embodiment, the molecular weight of the compound of formula (I) is in the range of 500 to 500,000 g/mol, such as 1000 to 500,000 g/mol, such as 1000 to 100,000 g/mol, 5000 to 100,000 g/mol or 5000 to 50,000 g/mol.

In one embodiment, at least one R3 is Si(R1)₂R2 or Si(R1)(R2)₂ or Si(R2)₃, preferably Si(R1)₂R2.

In another embodiment, both of R3 are Si(R1)₃.

In one embodiment, (n+m+p) is an integer from 5 to 5000; such as from 5 to 4000, such as from 5-3000, such as from 5-2000, preferably from 5 to 1000, more preferably from 20 to 1000 or from 20 to 500; and (m+p) is an integer from 1-40, such as from 1-30, such as from 1-20, such as from 1-10.

In a further embodiment, (n+m+p) is an integer from 5 to 5000; such as from 5 to 4000, such as from 5-3000, such as from 5-2000, preferably from 5 to 1000, more preferably from 20 to 1000 or from 20 to 500; and (m+p) is an integer from 1-40, such as from 1-30, such as from 1-20, such as from 1-10, and both of R3 are Si(R1)₃.

In a further embodiment, (n+m+p) is an integer from 5 to 5000; such as from 5 to 4000, such as from 5-3000, such as from 5-2000, preferably from 5 to 1000, more preferably from 20 to 1000 or from 20 to 500; and (m+p) is an integer from 0-40, such as from 0-30, such as from 0-20, such as from 0-10, and at least one R3 is Si(R1)₂R2 or Si(R1)(R2)₂ or Si(R2)₃, preferably Si(R1)₂R2.

In one embodiment, each R1 is individually selected from linear or branched C₁-C₆ alkyl, linear or branched C₂-C₆ alkenyl, C₃-C₆ cycloalkyl and aryl. In a further embodiment each R1 is individually selected from linear or branched C₁-C₃ alkyl, linear or branched C₂-C₃ alkenyl, cyclopropyl and phenyl. In one embodiment, all pendant R1 are selected from either methyl or phenyl. In a further embodiment, all R1 are selected from either methyl or phenyl. In a preferred embodiment all R1 are methyl.

In one embodiment, each R2 is individually selected from linear or branched C₁-C₁₀ alkyl, linear or branched C₂-C₁₀ alkenyl, C₃-C₁₀ cycloalkyl and aryl; substituted with at least one epoxy-functional group. In one embodiment, each R2 is selected from linear or branched C₁-C₃ alkyl, linear or branched C₂-C₃ alkenyl, cyclopropyl or aryl; substituted with at least one epoxy-functional group. In a preferred embodiment, all R2 are 1-propyl substituted with an epoxy-functional group.

The term “epoxy-functional group” refers to a monovalent organic group containing an oxirane-ring.

The term “monovalent organic group” as used herein refers to a group containing carbon and having only one binding site.

The epoxy-functional group may comprise compounds selected from the non-exhaustive list of formulas below

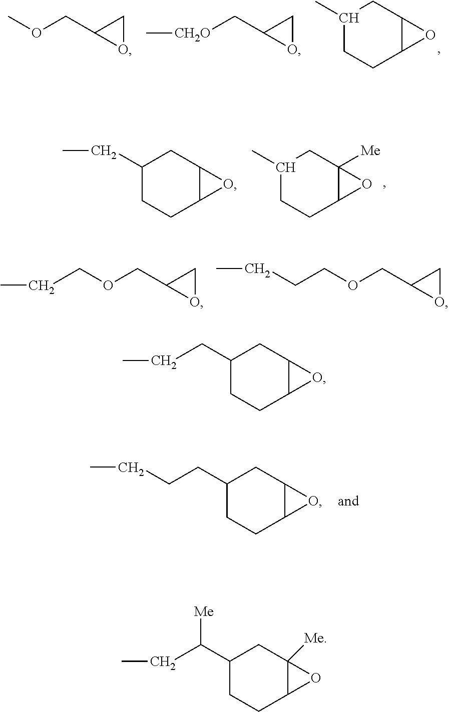

In a preferred embodiment, said epoxy-functional group is represented by the formula below

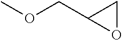

In a preferred embodiment R₂ is

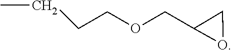

Commercial examples of epoxy-functional polysiloxanes include for example GP-607 and GP-554 from Genesee Polymers and DMS-E11 and DMS-E12 from Gelest.

### Amino-Functional Polysiloxane

The binder system may further comprise one or more amino-functional polysiloxane.

In the present context, the term “amino-functional polysiloxane” refers to a polysiloxane with at least one primary amino-functional group, or at least two secondary amino-functional groups, or at least one primary and at least one secondary amino-functional group. The amino-functional groups may be attached to the polysiloxane in terminal and/or pendant position through a carbon linkage.

The amino functionalities may, e. g., be introduced to the reactive polysiloxane by means of an aminosilane (i. e. an aminosilane such as those defined below), see e.g. U.S. Pat. No. 4,857,608. It should also be understood that the amino-functional polysiloxane may be prepared in situ. In some examples, a hydroxyl-functional or alkoxy-functional polysiloxane is reacted with an aminosilane whereby amino-functionalities are introduced. For example an aminosilane can be reacted with an α, ω-dihydroxypolydimethylsiloxane at a temperature in the range of 20-80° C., preferably using 0.4-1.2 alkoxy groups of the aminosilane per silanol group of the polysiloxane. If an excess of aminosilane is used, or if the reaction is not allowed to proceed to completion, a small amount of aminosilane may remain in the product. In one embodiment, at least one amino-functional polysiloxane is the reaction product of a polysiloxane and an aminosilane.

In one embodiment the amino-functional polysiloxane does not comprise hydrolysable and or condensable groups such as hydroxyl groups, alkoxy groups, acyloxy groups, ketimino groups, alkoxy groups and/or alkenyloxy groups.

At least two active hydrogens on the amino-functional polysiloxane are required for crosslinking with epoxy-functional polysiloxane. Thus, said amino-functional polysiloxane must contain at least one primary amino-functional group, or at least two secondary amino-functional groups, or at least one primary and at least one secondary amino-functional group.

In one embodiment, the amino-functional polysiloxane is represented by formula (II) below having a molecular weight in the range of 200 to 500,000 g/mol:

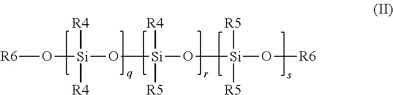

wherein q+r+s is an integer from 2 to 7500; and
wherein each R4 is individually selected from linear or branched C₁-C₃₀ alkyl, linear or branched C₂-C₃₀ alkenyl, C₃-C₃₀ cycloalkyl or aryl; and
wherein each R5 is individually selected from linear or branched C₁-C₃₀ alkyl, linear or branched C₂-C₃₀ alkenyl, C₃-C₃₀ cycloalkyl and aryl, and substituted with at least one amino-functional group; and wherein each R6 is individually selected from Si(R4)₃ and Si(R4)₂R5 and SiR4(R5)₂ and Si(R5)₃;
with the proviso that said amino-functional polysiloxane has at least one primary amino-functional group, or at least two secondary amino-functional groups, or at least one primary and at least one secondary amino-functional group.

In one embodiment, said amino-functional polysiloxane has at least one primary amino-functional group. In one embodiment, said amino-functional polysiloxane has at least two secondary amino-functional groups. In one embodiment, said amino-functional polysiloxane has at least one primary and at least one secondary amino-functional group.

In one embodiment, the molecular weight of the compound of formula (II) is in the range of 500 to 500,000 g/mol, such as 1000 to 500,000 g/mol, such as 1000 to 100,000 g/mol, 5000 to 100,000 g/mol or 5000 to 50,000 g/mol.

In one embodiment, both of R6 are Si(R4)₃. In another embodiment, at least one R6 is Si(R4)₂R5 or Si(R4)(R5)₂ or Si(R5)₃, preferably Si(R4)₂R5.

In one embodiment, (q+r+s) is an integer from 5 to 5000; such as from 5 to 4000, such as from 5-3000, such as from 5-2000, preferably from 5 to 1000, more preferably from 20 to 1000 or from 20 to 500; and (r+s) is an integer from 1-40, such as from 1-30, such as from 1-20, such as from 1-10.

In a further embodiment, (q+r+s) is an integer from 5 to 5000; such as from 5 to 4000, such as from 5-3000, such as from 5-2000, preferably from 5 to 1000, more preferably from 20 to 1000 or from 20 to 500; and (r+s) is an integer from 1-40, such as from 1-30, such as from 1-20, such as from 1-10; and both of R6 are Si(R4)₃.

In a further embodiment, (q+r+s) is an integer from 5 to 5000; such as from 5 to 4000, such as from 5-3000, such as from 5-2000, preferably from 5 to 1000, more preferably from 20 to 1000 or from 20 to 500; and (r+s) is an integer from 0-40, such as from 0-30, such as from 0-20, such as from 0-10; and at least one R6 is Si(R4)₂R5 or Si(R4) (R5)₂ or Si(R5)₃, preferably Si(R4)₂R5.

In one embodiment each R4 is individually selected from linear or branched C₁-C₆ alkyl, linear or branched C₂-C₆ alkenyl, C₃-C₆ cycloalkyl and aryl. In a further embodiment each R4 is individually selected from linear or branched C₁-C₃ alkyl, linear or branched C₂-C₃ alkenyl, cyclopropyl and phenyl. In one embodiment, all pendant R4 are selected from either methyl or phenyl, in a further embodiment, all R4 are selected from either methyl or phenyl. In a preferred embodiment, all R4 are methyl.

In one embodiment, R5 is selected from linear or branched C₁-C₃ alkyl, linear or branched C₂-C₃₀ alkenyl, cyclopropyl and aryl; substituted with at least one amino-functional group.

In a preferred embodiment, all R5 are 1-propyl substituted with an amino-functional group. In a further preferred embodiment, all R5 are 1-propyl substituted with a substituent selected from —NH₂ or —NH—CH₂—CH₂—NH₂.

Commercially available amino-functional polysiloxanes include for example Dowsil 3055 from Dow, GP-4 from Genesee Polymers, and Silamine A0-EDA from Siltech.

### Further Components in Binder System

The binder system may further comprise certain amounts of organic resins, such as polymers wherein the majority of the polymer backbone are based on carbon-carbon bonds. The term “organic resin” refers to a resin of organic nature, which may contain heteroatoms, but does not contain polymeric or oligomeric silicone, siloxane or silicate moieties. The organic resin may, however, contain alkoxysilyl-functional groups. Particular mention is made of epoxy resins, polyamides, nylons, polyesters, ABS combinations, halogenated polymers such as poly (vinyl chloride) (PVC), polyethylenes, polypropylenes, polyurethanes, polyacrylates/polymethacrylates (homo-and copolymers), polystyrenes, polychloropropene, phenolics, and co-polymers thereof. Particular mention is made of organic epoxy and amino resins.

The inventors have found that increased amount of organic resin in the binder system has a negative impact on the time to failure (Table 4). Thus, in a preferred embodiment, the content of any organic resin in the binder system is below 50% by weight of the binder system, such as below 40%, such as below 30%, preferably below 20%, such as below 15% or 10% or 5% by weight of the binder system. In one embodiment, the binder system does not contain any added organic resin meaning that only except for traces of organic resin or organic polymer that may be present in the commercial polysiloxanes there is no organic resin or organic polymer in the binder system. In one embodiment, the coating composition as such does not contain any organic resin.

### Catalyst

The coating composition further comprises one or more catalysts to allow and/or accelerate the formation of the binder system.

Surprisingly, the inventor has observed that the presence of one or more catalyst in the coating composition furthermore has an important impact on the fire performance properties of the coat. If no catalyst is present in the composition the time to failure is only around 40-65 minutes (Table 5). Furthermore, the selection of the one or more catalyst appears to have an effect on fire protection performance.

The one or more catalyst may be selected from known compounds used as catalysts in epoxy-epoxy reactions and/or epoxy-amine reactions. In one embodiment, the one or more catalyst is suitable for catalyzing epoxy-epoxy reactions, amine-epoxy reactions, or epoxy-epoxy and amine-epoxy reactions. Suitable catalysts include, but are not limited to, nucleophilic catalysts such as tertiary amines, phosphines and imidazoles and other heterocycles, Bronsted and Lewis acids such as alcohols, phenol derivatives, such as for example fluorophenol and nitrophenol, water, organic and inorganic acids. Other catalysts include metal salts, metal halides and triflates, and species that can decompose in strong acids, bases or nucleophiles after an external stimulus (e.g. UV light or a redox process) is applied, such as photoinitiators.

In one embodiment, the one or more catalyst comprises phenols such as phenol, 2-chlorophenol, 4-chlorophenol, 2,4-dichlorophenol, 2,4,6-trichlorophenol, fluorophenol, 2-nitrophenol, 4-nitrophenol, 2,4-dinitrophenol, 2,4,6-trinitrophenol, 2,4,6-Tri-(dimethylaminomethyl)phenol, 4-cyanophenol, o-cresol, m-cresol, p-cresol, 4-ethylphenol, 4-isopropylphenol, 2,4-dimethylphenol, 3,5-dimethylphenol, nonyl phenol, eugenol, isoeugenol, cardanol and other alkylated phenols, 2,2′-dihydroxybiphenyl, 2,4′-dihydroxybiphenyl, 4,4′-dihydroxybiphenol, bisphenol A, bisphenol F, catechol, 4-t-butyl catechol, resorcinol, 4-hexylresorcinol, orcinol, hydroquinone, naphthalenediol, anthracenediol, biphenylenediol and other substituted dihydric phenols, phloroglucinol, phloroglucide, calixarene, poly(4-vinylphenol) and other polyhydric phenols.

The one or more catalyst may be an organic catalyst. By “organic catalyst” is to be understood a catalyst comprising at least carbon and hydrogen atoms and optionally other atoms chosen from N, O, S, P and/or halogens. In one embodiment, the claimed one or more catalyst comprises an organic catalyst. In a further embodiment the one or more catalyst is an organic catalyst.

In the context of the invention, an “organic catalyst” provides a catalytic reaction without any influence from metal atoms. Preferably, said organic catalyst is void of any metal atoms with catalytic activity. I.e. preferably said organic catalyst does not comprise any metal atoms such as zinc, tin, magnesium, cobalt, calcium, titanium, aluminium, tannate, strontium, bismuth, and/or zirconium atoms with catalytic activity.

In one embodiment, the one or more catalyst comprises a tertiary amine, such as for example 2, 4, 6-tris(dimethylaminomethyl)phenol. In one embodiment, the one or more catalyst comprises a phenol derivative with electron-withdrawing substituents, such as fluorophenol or nitrophenol.

The catalyst may be used alone or as combination of two or more catalysts. In one embodiment, said catalyst comprises a mixture of tertiary amine and one or more phenol derivatives with electron-withdrawing substituents, such as fluorophenol or nitrophenol.

The amount and type of catalyst to be used must be adjusted depending on the reactivity of the catalyst, the functional groups on the binder system and the desired curing time and fire protection performance. Preferably, the total catalyst concentration is between 0.1-10.0%, such as between 0.5-10%, such as between 0.5-9%, such as between 0.5-8% or 0.5-7% or 0.5-6% or 0.5-5%; or between 1-10%, such as between 1-9%, such as between 1-8% or 1-7% or 1-6% or 1-5%; or between 2-10%, such as between 2-9%, such as between 2-8% or 2-7% or 2-6% or 2-5%, by weight of the coating composition.

In one embodiment, the catalyst has a Mw below 1000 g/mol, such as below 750, such as below 500, such as below 400 or 300 or 200 g/mol.

In a preferred embodiment, said one or more catalyst does not comprise any polymeric based catalysts. In a preferred embodiment, said one or more catalyst does not comprise any aminosilane.

In one embodiment, the claimed intumescent coating does not comprise a metallic catalyst. In one embodiment, the claimed one or more catalyst is not a metallic catalyst. By “metallic catalyst” is to be understood a catalyst comprising a metal atom. Non-limiting examples of metallic catalysts include tin-, titanium-, zinc-, aluminium-, bismuth-, zirconium-, stannate-, cobalt-, strontium-, magnesium- and calcium-containing catalysts.

### Intumescent Package

The claimed intumescent coating composition per se comprises intumescent components. To “intumesce” means to char and expand. In the context of the invention, “intumescent components” means components selected from acid-generating compounds, expansion agents and carbon donor compounds. In the present context, and “intumescent package” means a group of compounds comprising one or more first compound comprising an acid generating compound, optionally one or more second compound comprising an expansion agent and optionally one or more further compound comprising a carbon donor compound. The terms “spumific agents” or “intumescent ingredients” may be used interchangeably with the term “intumescent components”.

### Acid Generating Compound

The intumescent package c) comprises one or more first compound being an acid generating compound. The acid-generating compound (sometimes denoted char-forming agent) typically comprises a source of a strong acid, such as phosphoric or sulfonic acid, that is capable of producing the acid, such as phosphoric or sulfonic acid, respectively, upon exposure to heat, particularly at temperatures greater than 200° C. Examples of such sources include sodium phosphate, potassium phosphate (e.g. potassium tripolyphosphate), ammonium phosphate (e.g. ammonium polyphosphate (APP), monoammonium phosphate, diammonium phosphate), sodium sulfate, potassium sulfate, ammonium sulfate, magnesium sulfate, or para-toluene sulfonic acid, or a combination of any thereof.

In one embodiment, the acid-generating compound comprises a phosphoric acid ester of a polyhydroxy compound, or an ammonium phosphate (e.g., APP), or an amine phosphate (e.g., melamine phosphate), or a combination thereof. A particularly useful acid-generating compound is APP since it yields phosphoric acid at temperatures generally below the decomposition temperatures of the carbon donor compounds described below. Thus, in a preferred embodiment, said one or more acid generating compound comprises ammonium polyphosphate (APP).

APP produces phosphoric acid that is readily available to participate in the charring reactions. APP compounds are polymeric phosphates, having P—O—P linkages, which may be represented by the formula: [NH₄P0₃]ₙ wherein the average value of n is at least about 10. Particularly useful APP compounds in the intumescent coating compositions of the present invention include those having values of n>1000.

In one embodiment, the acid-generating compound may comprise boric acid or a source of boric acid that is capable of producing boric acid upon exposure to heat, particularly at temperatures greater than 200° C. The source of boric acid can comprise, for example, borate salts such as ammonium pentaborate, zinc borate, sodium borate, lithium borate, aluminum borate, magnesium borate, borosilicate compounds, and combinations of any thereof.

The amount of acid generating compound typically constitutes 10 to 50 wt %, such as 15 to 40 wt %, preferably 15 to 30 wt % or 15-25 wt % based on the total weight of the intumescent coating composition.

### Expansion Agent

The intumescent package per se comprises an expandable intumescent material. Typically the intumescent material comprises one or more second compound, which is in the present context denoted “expansion agent” (also sometimes denoted as a blowing agents). The expansion agent will produce non-flammable gases, generally nitrogen or ammonia, when exposed to fire or heat. The produced gases will expand the char, forming a foam-like protective layer, as further described below. Suitable examples of commercially available expansion agents include but are not limited to nitrogen-containing compounds such as glycine, melamine, melamine salts, melamine derivatives, urea, urea derivatives, dicyandiamide, guanidine, boron-containing compounds and isocyanurate derivatives; and combinations thereof.

Melamine derivatives include for example melamine formaldehyde, methylolated melamine, hexamethoxymethylmelamine, melamine monophosphate, di-melamine phosphate, melamine biphosphate, melamine polyphosphate, melamine pyrophosphate, melamine cyanurate, melamine borate, melam (N2-(4,6-diamino-1, 3, 5-triazin-2-yl)-1, 3, 5-triazine-2, 4, 6-triamine), melem (2,5,8-triamino-1,3,4,6,7,9,9b-heptaazaphenalene), and melon (poly[8-amino-1,3,4,6,7,9,9b-heptaazaphenalene-2, 5-diyl)imino). In one embodiment, the expansion agent comprises melamine. In one embodiment, the expansion agent does not comprise melamine. If the expansion agent comprises melamine, the amount of melamine is preferably below 15 wt % such as below 10 wt % based on the total weight of the intumescent composition. The expansion agent may still comprise melamine derivatives, such as for example melamine phosphate or melamine polyphosphate.

Urea derivatives include, for example, N-alkylureas such as methyl urea; N,N′-dialkylureas such as dimethylurea; and N,N,N′-trialkylureas such as timethylurea; guanylurea; guanylurea phosphate; formamide amino urea; guanylurea phosphate; 1,3-diamino urea; biurea; and the like.

Isocyanurate derivatives of interest include tris-(2-hydroxyethyl)isocyanurate (THEIC). Boron-containing compounds useful as expansion agents in the present invention include, but are not limited to, boric acid, and borates, such as ammonium pentaborate, zinc borate, sodium borate, lithium borate, aluminum borate, magnesium borate, and borosilicate.

The expansion agent may also comprise monomeric or polymeric compounds such as meso-lactide, polylactide, a polysulfone, a polycarbonate, a polyester, a 1,1-di-activated vinyl compound, or an addition polymer of a 1,1-di-activated vinyl compound, or a combination of any thereof. A physical expansion agent such as expandable graphite and/or gas incorporating expandable microspheres may also be used.

Certain acid generating compounds like for example ammonium (poly)phosphate and melamine (poly) phosphate may also be able to expand and provide the same properties as an added expansion agent (as indicated above). Thus, in one embodiment said one or more first compound being an acid generating compound also acts as an expansion agent.

Therefore, in one embodiment said c) intumescent package does not comprise any second compound being an expansion agent. In a further embodiment, no second compound comprising an expansion agent has been added when the first compound comprising an acid generating compound also acts as an expansion agent. For example, in one embodiment the one or more acid generating compound comprises APP or melamine phosphate, and no second compound comprising an expansion agent is included. In such cases, the one or more first compound acting both as acid generating compound and expansion agent may be present in an amount in the range of 10-50 wt %, such as 10-40%, such as 10-30wt % based on the weight of the total coating composition.

In one embodiment, one or more second compound being an expansion agent is included in the intumescent package. When one or more second compound being an expansion agent is included, the amount of said one or more second compound typically constitutes 0.5 to 15 wt %, preferably 1.0 to 10 wt %, more preferably 5.0 to 10 wt % based on the total weight of the intumescent coating composition. In one embodiment said c) intumescent package comprises one or more first compound being an acid generating compound, and one or more second compound being an expansion agent. In one embodiment, one or more second compound being an expansion agent is included even though the one or more first compound may also act as an expansion agent.

### Carbon Donor Compound

The intumescent coating composition must comprise a carbon source. In one embodiment, the intumescent package further comprises one or more further compound which is a carbon donor compound. The carbon donor compound, if present, may comprise an organic (poly)hydroxy compound (i.e. an organic (poly)alcohol) and/or expandable graphite. For example, the carbon donor compound may comprise pentaerythritol, dipentaerythritol, tripentaerythritol, a polysaccharide (e.g., starch, cellulose, glycogen, and the like), a disaccharide sugar (e.g., sucrose, lactose, maltose, and the like), a monosaccharide sugar (glucose, fructose, galactose, and the like), glycerol, or expandable graphite, or a combination of any thereof. Other examples can be hydrocarbon resins, paraffins, phosphate compounds, tall oil fatty acids (TOFA) or cardanol. Preferably the carbon donor compound is selected from pentaerythritol and dipentaerythritol. Combinations of carbon donor compounds may be used.

In some occasions the binder system per se is able to act as a carbon source and thus, it may be redundant to include a carbon donor compound in the intumescent package. In such cases, the char may be formed simply by reaction of the acid generating compound and a carbon donor present in the binder system.

Thus, in one embodiment, said c) intumescent package does not comprise any further compound being a carbon donor. In one embodiment, the binder system per se includes a carbon donor. In a further embodiment, the binder system per se includes a carbon donor and said c) intumescent package does not comprise any further compound being a carbon donor.

When a further compound being one or more carbon donor compound (not being part of the binder system) is included in the composition, said compound is typically included in an amount up to 20 wt %, such as in an amount up to 15%, such as in an amount up to 10%, for example in an amount of 3.0 to 20 wt %, such as 5.0 to 16 wt %, or 5.0 to 15 wt %, such as 1.0 to 12 wt %, or 5 to 10 wt % based on the weight of the intumescent coating composition.

In one embodiment, said c) intumescent package comprises one or more first compound being an acid generating compound, and one or more further compound being a carbon donor compound. In a further embodiment, said first compound being an acid generating compound also acts as an expansion agent. In one embodiment, said c) intumescent package comprises one or more first compound being an acid generating compound, one or more second compound being an expansion agent, and one or more further compound being a carbon donor compound.

In one embodiment the intumescent package contains less than 10% by weight expandable graphite.

### Flame Retardant Agent

The intumescent package may also comprise at least one flame retardant, such as a phosphorus containing flame retardant. Suitable flame retardants include phosphoric acid, phosphite, phosphonate and phosphoric acid esters. Triarylphosphate esters, especially triphenyl phosphate esters are preferred.

If present, the flame retardant agent, may be included in an amount up to 15 wt %, preferably 2.5 to 15 wt %, such as 2.5 to 12.5 wt %, or 3.0 to 10 wt % based on the total weight of the intumescent coating composition.

### Reaction Mechanism

When intumescent coatings are exposed to fire or heat, and the temperature of the coating exceeds for example 200° C., the acid generating compound decomposes to provide an acid. The carbon donor compound and/or the binder system may react with the acid to form a carbonaceous char. For example, an ammonium polyphosphate decomposes at about 240° C. to form ammonia and phosphoric acid. The phosphoric acid can function as an acid for dehydration reactions of organic polyol compounds such as starch, cellulose, non-polymeric sugars (e.g., glucose, fructose, sucrose, and the like), pentaerythritol, dipentaerythritol, or tripentaerythritol, or combinations of any thereof, which function as carbon donor compounds.

The phosphoric acid reacts with the hydroxyl groups to form heat-unstable phosphate esters, which decompose to release carbon dioxide and regenerate the phosphoric acid. The dehydrated carbon donor and/or the binder system forms the carbonaceous char, and the carbon dioxide expands the char into a foam. The expandable material likewise decomposes at elevated temperatures (e.g., greater than 200° C.) and produces additional gas that volumetrically expands the carbonaceous char and produces the carbonaceous foam.

In one embodiment, the intumescent components are present in amounts such that the intumescent coating is capable of swelling to at least two times, such as at least three times, such as at least 5 times or maybe even up to ten times or more relative to its original volume when exposed to fire temperatures. The temperature in a fire may be anywhere in the range 150-1000° C. or even higher, and it is preferred that the composition starts to intumesce at a temperature in the lower part of this range. The number of times the coating swells compared to its original film thickness is typically referred to as its expansion ratio.

In the context of the invention, the intumescent package is typically present in an amount of 30-50% by weight of the coating composition, such as 30-45%, or 35-50%, preferably 35-45%.

### Fibers

In order to increase the structural strength of the char foam, fibers or glass reinforcing materials may optionally be added to the intumescent coating composition. Suitable inorganic and organic fibers as well as of glass reinforcing materials are known in the art. The intumescent coating composition of the present invention works well without fibers added as illustrated by the working examples. If fibers are present in the coating composition, these may typically be added in amounts up to 20%, such as up to 15%, such as up to 10%, such as up to 5% by weight of the composition.

### Further Components

The claimed intumescent coating composition typically also comprises further components selected from fillers, pigments and additives not being part of the intumescent package. Thus, in one embodiment, said intumescent coating composition further comprises d) one or more components selected from pigments, fillers, additives and solvents.

Pigments and fillers are in the present context viewed in conjunction as constituents that may be added to the coating composition.

Examples of pigments are grades of titanium dioxide, red iron oxide, zinc oxide, carbon black, graphite, yellow iron oxide, red molybdate, yellow molybdate, zinc sulfide, antimony oxide, sodium aluminium sulfosilicates, quinacridones, phthalocyanine blue, phthalocyanine green, black iron oxide, indanthrone blue, cobalt aluminium oxide, carbazole dioxazine, chromium oxide, isoindoline orange, bis-acetoacet-o-tolidiole, benzimidazolon, quinaphtalone yellow, isoindoline yellow, tetrachloroisoindolinone, quinophthalone yellow.

Examples of fillers are calcium carbonate such as calcite, dolomite, talc, mica, feldspar, barium sulfate, kaolin, nepheline, silica (including hydrophilic and hydrophobic silica), perlite, magnesium oxide, and quartz flour, etc.

Any pigments and/or fillers may typically constitute 0-60%, such as 0-50%, preferably 5-45%, such as 5-40%, or 5-35%, or 5-25%, or 5-20%, or 10-20% such as 10-15 or 15-20% by weight of the coating composition.

In one embodiment, said intumescent coating composition further comprises d) one or more pigments. In a preferred embodiment, said one or more pigment comprises titanium dioxide.

Examples of additives are:
(i) non-reactive fluids such as non-reactive organopolysiloxanes; for example unsubstituted polydimethylsiloxane, methylphenyl polysiloxane; petroleum oils and combinations thereof;
(ii) surfactants such as derivatives of propylene oxide or ethylene oxide such as alkylphenol-ethylene oxide condensates (alkylphenol ethoxylates); ethoxylated monoethanolamides of un-saturated fatty acids such as ethoxylated monoethanolamides of linoleic acid; sodium dodecyl sulfate; and soya lecithin;
(iii) wetting agents and dispersants such as those described in M. Ash and I. Ash, “Handbook of Paint and Coating Raw Materials, Vol. 1”, 1996, Gower Publ. Ltd., Great Britain, pp 821-823 and 849-851;
(iv) thickeners and anti-settling agents (e.g. thixotropic agents) such as colloidal silica, hydrated aluminium silicate (bentonite), aluminium tristearate, aluminium monostearate, xanthan gum, chrysotile, pyrogenic silica, hydrogenated castor oil, organo-modified clays, polyamide waxes and polyethylene waxes;
(v) dyes such as 1,4-bis(butylamino)anthraquinone and other anthraquinone derivatives; toluidine dyes, etc.; and
(vi) antioxidants such as bis(tert-butyl) hydroquinone, 2,6-bis(tert-butyl) phenol, resorcinol, 4-tert-butyl catechol, tris(2,4-di-tert-butylphenyl)phosphite, pentaerythritol Tetrakis(3-(3,5-di-tert-butyl-4-hydroxyphenyl)propionate), bis(2,2,6,6,-tetramethyl-4-piperidyl)sebacate, etc.
(vii) adhesion promotors such as for example aminosilane or epoxysilane.

Any additives may typically constitute 0-30%, such as 0-15%, by weight of the coating composition. Preferably, the coating composition comprises one or more thickeners and/or anti-settling agents (e.g. thixotropic agents), preferably in an amount of 0.2-10%, such as 0.5-5%, e.g. 0.6-4%, by weight of the coating composition.

Moreover, the coating composition may be supplemented with one or more solvents. Examples of solvents are aliphatic, cycloaliphatic and aromatic hydrocarbons such as white spirit, cyclohexane, toluene, xylene and naphtha solvent, esters such as methoxypropyl acetate, n-butyl acetate and 2-ethoxyethyl acetate; and mixtures thereof. Alternatively, the solvent system may include water or be water-based (>50% water in the solvent system). Preferably the solvents have a boiling point of 110° C. or more. The intumescent coating composition of the invention may be prepared in solvent-free form and thus, provide a good environmental profile. If any solvent is included in the composition it is preferably included in an amount of less than 20% by weight, such as less than 15% by weight, such as less than 10% by weight, preferably less than 5%, such as less than 2.5% by weight of the coating composition. In one embodiment, the coating composition is substantially free of any solvents meaning that solvents have not been explicitly added. If at all, only small amounts of one or more solvents are present in the coating composition as a result of the use of components, which may be optionally obtained commercially in solution in organic solvents. The volatile organic content (VOC) of the coating compositions can be less than 300 g/L, such as less than 250 g/L, less than 150 g/L, less than 100 g/L or even less than 50 g/L.

### Preparation of the Coating Composition

The coating composition may be prepared by any suitable technique that is commonly used within the field of paint production. Thus, the various constituents may be mixed together utilizing a mixer, a high speed disperser, a ball mill, a pearl mill, a grinder, a three-roll mill etc.

The coating composition is typically prepared by mixing two or more components. Possible examples include e.g. two pre-mixtures, one pre-mixture comprising the one or more epoxy-functional polysiloxane and another pre-mixture comprising the one or more catalyst. Optionally combined with a third pre-mixture comprising one or more amino-functional polysiloxane. Either of these pre-mixtures contain or can contain the intumescent components. The acid-generating compound is included in the pre-mixture without amino-functional polysiloxane to avoid premature reaction with the active hydrogens. Said pre-mixtures may optionally further comprise components selected from solvents, additives, fillers and pigments. The pre-mixtures may further optionally comprise fibers or glass reinforcing material to increase the strength of the char foam.

### Kits of Parts

The coating compositions may be shipped as two-or three-component systems that should be combined and thoroughly mixed immediately prior to use. Thus, in one aspect, the invention also relates to a kit of parts suitable for the formulation of the claimed coating composition, comprising two or three containers comprising components for preparation of the intumescent coating composition.

In one embodiment, the invention relates to a kit of parts suitable for the formulation of an intumescent coating composition comprising a polysiloxane based binder system, wherein said kit comprises A1) a first container containing one or more epoxy-functional polysiloxane as previously described and B) a second container containing one or more catalyst as previously described. In one embodiment, said kit further comprises A2) a third container containing one or more amino-functional polysiloxane as previously described. In one embodiment, said container A1) and/or said container A2) further contains one or more catalyst as previously described.

In one embodiment, the invention relates to a kit of parts suitable for the formulation of an intumescent coating composition comprising a polysiloxane based binder system, wherein said kit comprises A1) a first container containing one or more epoxy-functional polysiloxane as previously described and A2) a second container containing one or more amino-functional polysiloxane as previously described, wherein: said kit further comprises a third container containing one or more catalyst as previously described and/or said container A1) further contains one or more catalyst kit and/or said container A2) further contains one or more catalyst as previously described.

The intumescent components may be included in any appropriate container, preferably in one or both of the containers comprising epoxy-functional polysiloxane and/or amino-functional polysiloxane. Thus in an embodiment referring to the variations of kits of parts described above, said container A1) and/or said container A2) further contains one or more of the intumescent components previously described. In a preferred embodiment, the acid generating component is included in container A1) containing the one or more epoxy-functional polysiloxane.

In one embodiment referring to the variations of kits of parts described above, said container A1) and said container A2) each contains the one or more epoxy-functional polysiloxane and the one or more amino-functional polysiloxane in amounts such than when mixing the content of the containers in the right proportion, the stoichiometry between active hydrogens on the amino-functional polysiloxane relative to epoxy groups on the epoxy-functional polysiloxane is at least 5%, such as at least 10%, preferably at least 15%, such as at least 20%, such as at least 25%, such as at least 30, 40, 50, 60, 70, 80 90 or 100%.

It should be understood that when reference is made to the “coating composition”, it refers to the mixed composition comprising all constituents, ready to be applied on a substrate. Furthermore, all amounts stated as % by weight of the coating composition should be understood as % by weight of the mixed coating composition ready to be applied, i.e. the weight including the solvents (if any).

### Application of the Intumescent Coating Composition

The coating composition of the invention is typically applied to at least a part of the surface of a substrate.

The term “applying” is used in its normal meaning within the paint industry. Thus, “applying” is conducted by means of any conventional means, e.g. by brush, by roller, by spraying, by dipping, etc. The commercially most interesting way of “applying” the coating composition is by spraying. Hence, the coating composition is preferably sprayable. Spraying is effected by means of conventional spraying equipment known to the person skilled in the art.

The intumescent coating composition is applied to provide a high dry film thickness to ensure a good fire protection. The applied film thickness may vary depending on the nature of substrate being coated and its predicted fire exposure scenario. The dry film thickness of the coat obtained from the intumescent coating composition is preferably in the range of 0.1-40 mm, such as 0.5-40 mm, such as 0.5-30 mm, such as 0.5-25 mm or 0.1-30 mm, such as 0.1-25 mm. The intumescent coating composition may be applied in several layers to achieve the appropriate dry film thickness.

In one aspect, the invention relates to the use of the claimed intumescent coating composition for application on the surface on a substrate such as on a metal or metal alloy substrate, such as a steel substrate. The intumescent coating composition of the present invention is typically used to fire-proof buildings. The composition may be applied to the framework of the building, typically made of steel, either in the metal-forming plant, in an application shop (“off-site”) or on-site after the framework has been erected.

In some instances it may be relevant to embed a high-temperature resistant mesh in the intumescent coating layer as described in e.g. WO 2016/0949763. Examples of mesh materials include metal wire mesh, glass fiber mesh, carbon fiber mesh and refractory mineral fiber mesh (e.g., basalt).

The surface to which the intumescent coating is applied may be the “native” surface (e.g. a steel surface). However, the substrate to be coated may in some instances already have an existing coat, for example a primer and/or a tie coat, so that the surface to be coated by the intumescent coating composition is constituted by such a coat. Examples of suitable primers are coatings based on epoxy, polyurethane, acrylic, vinyl and chlorinated rubber. Epoxy primers are preferred. Alternatively, the substrate may have an older coat applied on the surface, e.g. a worn-out fire intumescent coat, or similar.

A decorative or protective topcoat may be applied on top of the cured intumescent coating of the present invention, e.g to provide color to exposed steelwork or to protect against harsh environmental conditions

The term “substrate” refers to a solid material onto which the coating composition is applied. The substrate typically comprises a metal or a metal alloy, such as steel or iron. Other substrates may also be relevant such as concrete, wood or aluminium.

In one aspect, the invention relates to a substrate having on at least a part of the surface, a coat obtained from the claimed intumescent coating composition. In a preferred embodiment, said substrate constitutes at least a part of the framework of a building.

In one embodiment, said substrate is having on at least a part of the surface a multilayer system comprising
i) one or more layers of a cured primer and/or tiecoat; and
ii) one or more layers of coat obtained from the coating composition according to the invention.

In a further embodiment, said multilayer system further comprises iii) one or more layers of topcoat, such as a decorative or protective topcoat.

In one embodiment, said primer is an anticorrosive primer.

The term “surface” is used in its normal sense, and refers to the exterior boundary of an object. Particular examples of such surfaces are the surface of a metal structure or a metal alloy structure such as a steel structure.

All references, including publications, patent applications, and patents, cited herein are hereby incorporated by reference in their entirety and to the same extent as if each reference were independently and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context. For example, the phrase “the composition” is to be understood as referring to various “compositions” of the invention or particular described aspect, unless otherwise indicated.

The description herein of any aspect or aspect of the invention using terms such as “comprising”, “having,” “including” or “containing” with reference to an element or elements is intended to provide support for a similar aspect or aspect of the invention that “consists of”, “consists essentially of” or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

The use of any and all examples, or exemplary language (including “for instance”, “for example”, “e.g.”, and “such as”) in the present specification is intended merely to better illuminate the invention, and does not pose a limitation on the scope of invention unless otherwise indicated.

Headings and sub-headings are used herein for convenience only, and should not be construed as limiting the invention in any way. The use of any and all examples, or exemplary language (including “for instance”, “for example”, “e.g.”, and “such as”) in the present specification is intended merely to better illuminate the invention, and does not pose a limitation on the scope of invention unless otherwise indicated. The citation and incorporation of patent documents herein is done for convenience only, and does not reflect any view of the validity, patentability and/or enforceability of such patent documents.

It should be understood that the various aspects, embodiments, implementations and features of the invention mentioned herein may be claimed separately, or in any combination.

### EXPERIMENTAL

The invention will be illustrated by the following non-limiting examples.

The terms “epoxy-functional polysiloxane” and “amino-functional polysiloxane” has for simplicity been reduced to “epoxy polysiloxane” and “amine polysiloxane” in the examples.

### Fire Testing

Fire tests were conducted following the ISO 834 fire curve in a gas furnace. All coating compositions were applied manually by either trowel or by pouring the paint until a 5000 μm Film Thickness was achieved. 200×300×5 mm primed steel panels (Hempel's 15280 primer, 20 μm DFT) were used, with a mould around them to confine the liquid until it was a solid. The panels were left curing at 23° C. and demoulded once the paint was hard enough to resist the process (typically 12-24 h). Afterwards, they were left to cure at 23° C. until a total curing time of seven days before being tested. All times to failure (TTF) reported have been corrected to account for small DFT deviations using the formula below:

$${TTF}_{corrected} = {TTF}_{measured} \cdot \frac{5000}{{DFT}_{measured}}$$

### Hardness Development

Samples were applied on a flat, plastic surface at a 3-5 mm thickness and left curing at 23° C. Shore A and Shore D measurements were carried out 24 h, 48 h and 7 days after the application using a durometer. Results reported represent the average hardness value obtained after three measurements (the higher value, the harder).

### List of Raw Materials:

Epoxy polysiloxane I: GP-554 from Genesee Polymers
Epoxy polysiloxane II: GP-607 from Genesee Polymers
Amine polysiloxane I: Dowsil 3055 from Dow
Amine polysiloxane II: Wacker Fluid NH 02 D from Wacker
Amine polysiloxane III: Silamine A0-EDA from Siltech
Organic (epoxy) resin: Epikote 828 from Hexion, (Bishenol A diglycidylether)
epoxy curing agent: Ancamide 903 MAV from Evonik, (Aliphatic polyamide amine)
Acid generating compound: Exolit AP 422, from Clariant (Ammonium polyphosphate)
Catalyst I: Ancamine K 54, from Evonik, (2,4,6-tris(dimethylaminomethyl)phenol)
Catalyst II: 2-Fluorophenol from Sigma-Aldrich and TCI chemicals
Catalyst III: 2-Nitrophenol from Sigma-Aldrich and TCI chemicals
Expansion agent: Melafine from OCI nitrogen, (melamine)
Carbon donor compound: Charmor PM 40 from Perstorp (Pentaerythritol)
Pigment: Tioxide TR 81 from Venator (titanium dioxide)

### Preparation of the Exemplified Coating Compositions

All coating compositions were formulated to have a 40% volume content of intumescent components and pigment (acid generating compound+expansion agent+carbon donor compound+pigment), and the stoichiometry and polysiloxane content stated in the tables below. The weight ratio between the acid generating compound, expansion agent, carbon donor compound and pigment was kept constant at 3:1:2:2. The catalyst content was present in a 9:1 binder/catalyst weight ratio.

Each formula was split into two different parts or containers. Part A had the epoxy-functional resin(s) and optionally, any Lewis or Bronsted acid catalyst present in the composition. Part B contained the amino-functional resin(s) and/or any nucleophilic catalyst used. APP was always dispersed into part A to avoid premature reaction with the nucleophiles in part B. All other components were split between parts A and B in amounts allowing for manufacture. Dispersion was always carried out using standard High Speed Dispersers (HSD). Parts A and B, were mixed right before application with the help of a mixer.

The amounts of each component indicated in the tables below are given in percentages by weight of each total coating composition.

“Stoichiometry” indicates the % stoichiometry between active hydrogens of the amino groups and the epoxy groups.

TABLE 1a
Epoxy polysiloxane II and increasing stoichiometries of amine polysiloxane I, catalyst I.

| | | A | B | C | D | E | F | G | H | I |
|---|---|---|---|---|---|---|---|---|---|---|
| Binder | Epoxy polysiloxane I | — | — | — | — | — | — | — | — | — |
| | Epoxy polysiloxane II | 38.6 | 36.5 | 34.6 | 32.9 | 31.4 | 30.0 | 24.5 | 20.8 | 18.0 |
| | Amine polysiloxane I | — | 2.3 | 4.3 | 6.1 | 7.8 | 9.3 | 15.2 | 19.3 | 22.3 |
| | Amine polysiloxane II | — | — | — | — | — | — | — | — | — |
| | Amine polysiloxane III | — | — | — | — | — | — | — | — | — |
| | Organic (epoxy) resin | — | — | — | — | — | — | — | — | — |
| | Epoxy curing agent | — | — | — | — | — | — | — | — | — |
| Catalyst | Catalyst I | 4.3 | 4.3 | 4.3 | 4.3 | 4.4 | 4.4 | 4.4 | 4.4 | 4.5 |
| | Catalyst II | — | — | — | — | — | — | — | — | — |
| | Catalyst III | — | — | — | — | — | — | — | — | — |
| Intumescent | Acid generating compound | 21.4 | 21.3 | 21.3 | 21.2 | 21.2 | 21.1 | 20.9 | 20.8 | 20.7 |
| package | Expansion agent | 7.1 | 7.1 | 7.1 | 7.1 | 7.1 | 7.0 | 7.0 | 6.9 | 6.9 |
| | Carbon donor compound | 14.3 | 14.2 | 14.2 | 14.2 | 14.1 | 14.1 | 14.0 | 13.9 | 13.8 |
| Pigment | Titanium dioxide | 14.3 | 14.2 | 14.2 | 14.2 | 14.1 | 14.1 | 14.0 | 13.9 | 13.8 |
| | Stoichiometry (%) | 0 | 5 | 10 | 15 | 20 | 25 | 50 | 75 | 100 |
| | wt % organic resin | — | — | — | — | — | — | — | — | — |
| | Furnace C-TTF | 88 | 92 | 88 | 82 | 80 | 75 | 79 | 83 | 81 |
| | (Average, 550° C.) | | | | | | | | | |
| Hardness | Shore D 7 days | 15 | 55 | 76 | 76 | 81 | 81 | 86 | 81 | 86 |
| development | | | | | | | | | | |

TABLE 1b
Epoxy polysiloxane I and increasing stoichiometries of amine polysiloxane I, catalyst I.

| | | J | K | L | M | N | O | P | Q | R |
|---|---|---|---|---|---|---|---|---|---|---|
| Binder | Epoxy polysiloxane I | 40.4 | 38.2 | 36.2 | 34.4 | 32.7 | 31.3 | 25.5 | 21.5 | 18.6 |
| | Epoxy polysiloxane II | — | — | — | — | — | — | — | — | — |
| | Amine polysiloxane I | — | 2.3 | 4.4 | 6.2 | 7.9 | 9.4 | 15.4 | 19.4 | 22.4 |
| | Amine polysiloxane II | — | — | — | — | — | — | — | — | — |
| | Amine polysiloxane III | — | — | — | — | — | — | — | — | — |
| | Organic (epoxy) resin | — | — | — | — | — | — | — | — | — |
| | Epoxy curing agent | — | — | — | — | — | — | — | — | — |
| Catalyst | Catalyst I | 4.5 | 4.5 | 4.5 | 4.5 | 4.5 | 4.5 | 4.5 | 4.6 | 4.6 |
| | Catalyst II | — | — | — | — | — | — | — | — | — |
| | Catalyst III | — | — | — | — | — | — | — | — | — |
| Intumescent | Acid generating compound | 20.7 | 20.6 | 20.6 | 20.6 | 20.6 | 20.6 | 20.5 | 20.4 | 20.4 |
| package | Expansion agent | 6.9 | 6.9 | 6.9 | 6.9 | 6.9 | 6.9 | 6.8 | 6.8 | 6.8 |
| | Carbon donor compound | 13.8 | 13.8 | 13.7 | 13.7 | 13.7 | 13.7 | 13.6 | 13.6 | 13.6 |
| Pigment | Titanium dioxide | 13.8 | 13.8 | 13.7 | 13.7 | 13.7 | 13.7 | 13.6 | 13.6 | 13.6 |
| | Stoichiometry | 0 | 5 | 10 | 15 | 20 | 25 | 50 | 75 | 100 |
| | wt % organic resin | — | — | — | — | — | — | — | — | — |
| | Furnace C-TTF | 92.7 | 97.9 | 81.3 | 82.2 | 84.0 | 82.8 | 79.4 | 79.2 | 80.7 |
| | (Average, 550° C.) | | | | | | | | | |
| | Shore D 7 days | 18 | 55 | 66 | 77 | 81 | 82 | 82 | 80 | 77 |

TABLE 1c
Epoxy polysiloxane I and various stoichiometries
of amine polysiloxane II and III, catalyst I.

| | | S | T | U | V |
|---|---|---|---|---|---|
| Binder | Epoxy polysiloxane I | 30.7 | 37.4 | 25.2 | 35.1 |
| | Epoxy polysiloxane II | — | — | — | — |
| | Amine polysiloxane I | — | — | — | — |
| | Amine polysiloxane II | 8.8 | 2.7 | — | — |
| | Amine polysiloxane III | — | — | 14.6 | 5.1 |
| | Organic (epoxy) resin | — | — | — | — |
| | Epoxy curing agent | — | — | — | — |
| Catalyst | Catalyst I | 4.4 | 4.5 | 4.4 | 4.5 |
| | Catalyst II | — | — | — | — |
| | Catalyst III | — | — | — | — |
| Intumescent | Acid generating compound | 21.0 | 20.8 | 20.9 | 20.8 |
| package | Expansion agent | 7.0 | 6.9 | 7.0 | 6.9 |
| | Carbon donor compound | 14.0 | 13.9 | 14.0 | 13.8 |
| Pigment | Titanium dioxide | 14.0 | 13.9 | 14.0 | 13.8 |
| | Stoichiometry | 100 | 25 | 100 | 25 |
| | wt % organic resin | — | — | — | — |
| | Furnace C-TTF | 92 | 124 | 118 | 117 |
| | (Average, 550° C.) | | | | |
| Hardness | Shore D 7 days | 75 | 70 | 77 | 70 |
| development | | | | | |

Table 1a, 1b and 1c shows that catalyst I (2,4,6-tris(dimethylaminomethyl)phenol)) provided an intumescent coat with good fire protection regardless of the choice of polysiloxane. Fire protection performance demonstrated by time to failure is in the range of 75-125 minutes. Hardness development improved when epoxy polysiloxane was crosslinked with amine polysiloxane. In particular when the stoichiometry was at least 10% fire performance was very good.

TABLE 2a
Epoxy polysiloxane II, amine polysiloxane I, catalyst I and II.

| | | W | X | Y |
|---|---|---|---|---|
| Binder | Epoxy polysiloxane I | — | — | — |
| | Epoxy polysiloxane II | 38.9 | 30.1 | 18.0 |
| | Amine polysiloxane I | — | 9.3 | 22.3 |
| | Amine polysiloxane II | — | — | — |
| | Amine polysiloxane III | — | — | — |
| | Organic (epoxy) resin | — | — | — |
| | Epoxy curing agent | — | — | — |
| Catalyst | Catalyst I | 2.9 | 2.9 | 3.0 |
| | Catalyst II | 1.4 | 1.5 | 1.5 |
| | Catalyst III | — | — | — |
| Intumescent | Acid generating compound | 21.3 | 21.1 | 20.7 |
| package | Expansion agent | 7.1 | 7.0 | 6.9 |
| | Carbon donor compound | 14.2 | 13.8 | 13.8 |
| Pigment | Titanium dioxide | 14.2 | 13.8 | 13.8 |
| | Stoichiometry | 0 | 25 | 100 |
| | wt % organic resin | — | — | — |
| | Furnace C-TTF | 146 | 148 | 131 |
| | (Average, 550° C.) | | | |
| Hardness | Shore A 7 days | 90 | >95 | >95 |
| development | Shore D 7 days | 28 | 76 | 45 |

As outlined in Table 2a, the combination of catalyst I and II provided an intumescent coat with excellent fire protection performance demonstrated by time to failure in the range of 130-150 minutes. Hardness development improved when epoxy polysiloxane was crosslinked with amine polysiloxane.

TABLE 3a
Epoxy polysiloxane I, various stoichiometries
of amine polysiloxane I, catalyst I and III.

| | | Z | AA | AB | AC | AD |
|---|---|---|---|---|---|---|
| Binder | Epoxy polysiloxane I | 40.7 | 31.5 | 25.7 | 21.7 | 18.8 |
| | Epoxy polysiloxane II | — | — | — | — | — |
| | Amine polysiloxane I | — | 9.5 | 15.5 | 19.6 | 22.6 |
| | Amine polysiloxane II | — | — | — | — | — |
| | Amine polysiloxane III | — | — | — | — | — |
| | Organic (epoxy) resin | — | — | — | — | — |
| | Epoxy curing agent | — | — | — | — | — |
| Catalyst | Catalyst I | 3.0 | 3.0 | 3.1 | 3.1 | 3.1 |
| | Catalyst II | — | — | — | — | — |
| | Catalyst III | 1.5 | 1.5 | 1.5 | 1.5 | 1.5 |
| Intumescent | Acid generating | 20.6 | 20.4 | 20.4 | 20.3 | 20.3 |
| package | compound | | | | | |
| | Expansion agent | 6.9 | 6.8 | 6.8 | 6.8 | 6.8 |
| | Carbon donor | 13.7 | 13.6 | 13.6 | 13.5 | 13.5 |
| | compound | | | | | |
| Pigment | Titanium dioxide | 13.7 | 13.6 | 13.6 | 13.5 | 13.5 |
| | Stoichiometry | 0 | 25 | 50 | 75 | 100 |
| | wt % organic resin | — | — | — | — | — |
| | Furnace C-TTF | 108 | 97 | 104 | 99 | 99 |
| | (Average, 550° C.) | | | | | |
| Hardness | Shore D 7 days | 25 | 65 | 68 | 79 | 80 |
| development | | | | | | |

TABLE 3b
Epoxy polysiloxane II, various stoichiometries
of amine polysiloxane I, catalyst I and III.

| | | AF | AG | AH | AI | AJ |
|---|---|---|---|---|---|---|
| Binder | Epoxy polysiloxane I | — | — | — | — | — |
| | Epoxy polysiloxane II | 38.9 | 30.2 | 24.7 | 20.9 | 18.1 |
| | Amine polysiloxane I | — | 9.3 | 15.3 | 19.4 | 22.4 |
| | Amine polysiloxane II | — | — | — | — | — |
| | Amine polysiloxane III | — | — | — | — | — |
| | Organic (epoxy) resin | — | — | — | — | — |
| | Epoxy curing agent | — | — | — | — | — |
| Catalyst | Catalyst I | 2.9 | 2.9 | 3.0 | 3.0 | 3.0 |
| | Catalyst II | — | — | — | — | — |
| | Catalyst III | 1.4 | 1.5 | 1.5 | 1.5 | 1.5 |
| Intumescent | Acid generating | 21.3 | 21.0 | 20.8 | 20.7 | 20.6 |
| package | compound | | | | | |
| | Expansion agent | 7.1 | 7.0 | 6.9 | 6.9 | 6.9 |
| | Carbon donor | 14.2 | 14.0 | 13.9 | 13.8 | 13.7 |
| | compound | | | | | |
| Pigment | Titanium dioxide | 14.2 | 14.0 | 13.9 | 13.8 | 13.7 |
| | Stoichiometry | 0 | 25 | 50 | 75 | 100 |
| | wt % organic resin | — | — | — | — | — |
| | Furnace C-TTF | 102 | 87 | 98 | 93 | 101 |
| | (Average, 550° C.) | | | | | |
| | Shore D 7 days | 24 | 53 | 79 | 83 | 78 |

Table 3a and 3b show that the combination of catalyst I and III provided an intumescent coat with a time to failure in the range of 85-110 minutes. Hardness development improved with increasing amounts of amine polysiloxane.

TABLE 4
Epoxy homopolymer with increasing amount of organic resin

| | | AK | AL | AM | AN | AO | AP | AQ | AR |
|---|---|---|---|---|---|---|---|---|---|
| Binder | Epoxy polysiloxane I | — | — | — | — | 38.5 | 36.5 | 32.6 | 20.7 |
| | Epoxy polysiloxane II | 36.8 | 35.1 | 31.5 | 20.2 | — | — | — | — |
| | Amine polysiloxane I | — | — | — | — | — | — | — | — |
| | Amine polysiloxane II | — | — | — | — | — | — | — | — |
| | Amine polysiloxane III | — | — | — | — | — | — | — | — |
| | Organic (epoxy) resin | 1.9 | 3.9 | 7.9 | 20.2 | 2.0 | 4.1 | 8.2 | 20.7 |
| | Epoxy curing agent | — | — | — | — | — | — | — | — |
| Catalyst | Catalyst I | 4.3 | 4.3 | 4.4 | 4.5 | 4.5 | 4.5 | 4.5 | 4.6 |
| | Catalyst II | — | — | — | — | — | — | — | — |
| | Catalyst III | — | — | — | — | — | — | — | — |
| Intumescent | Acid generating compound | 21.3 | 21.3 | 21.1 | 20.6 | 20.6 | 20.6 | 20.5 | 20.2 |
| package | Expansion agent | 7.1 | 7.1 | 7.0 | 6.9 | 6.9 | 6.9 | 6.8 | 6.7 |
| | Carbon donor compound | 14.2 | 14.2 | 14.1 | 13.8 | 13.8 | 13.7 | 13.7 | 13.5 |
| Pigment | Titanium dioxide | 14.2 | 14.2 | 14.1 | 13.8 | 13.8 | 13.7 | 13.7 | 13.5 |
| | Stoichiometry | — | — | — | — | — | — | — | — |
| | wt % organic resin | 5 | 10 | 20 | 50 | 5 | 10 | 20 | 50 |
| | Furnace C-TTF | 92 | 85 | 80 | 76 | 89 | 78 | 79 | 79 |
| | (Average, 550° C.) | | | | | | | | |
| Hardness | Shore D 7 days | — | — | — | — | — | — | — | — |
| development | | | | | | | | | |

Table 4 shows that increasing amounts of organic resin in the binder system had a negative impact on the fire protection performance.

TABLE 5
Comparative formulations with no catalyst

| | | A | B | C | D |
|---|---|---|---|---|---|
| | | comp. | comp. | comp. | comp. |
| Binder | Epoxy polysiloxane I | — | — | 20.9 | 24.1 |
| | Epoxy polysiloxane II | 20.1 | 23.1 | — | — |
| | Amine polysiloxane I | 24.9 | 21.5 | 25.1 | 21.7 |
| | Amine polysiloxane II | — | — | — | — |
| | Amine polysiloxane III | — | — | — | — |
| | Organic (epoxy) resin | — | — | — | — |
| | Epoxy curing agent | — | — | — | — |
| Catalyst | Catalyst I | — | — | — | — |
| | Catalyst II | — | — | — | — |
| | Catalyst III | — | — | — | — |
| Intu- | Acid generating | 20.7 | 20.7 | 20.3 | 20.3 |
| mescent | compound | | | | |
| package | Expansion agent | 6.9 | 6.9 | 6.8 | 6.8 |
| | Carbon donor | 13.8 | 13.8 | 13.5 | 13.5 |
| | compound | | | | |
| Pigment | Titanium dioxide | 13.8 | 13.8 | 13.5 | 13.5 |
| | Stoichiometry | 100 | 75 | 100 | 75 |
| | wt % organic resin | — | — | — | — |
| | Furnace C-TTF | 43 | 65 | 55 | 44 |
| | (Average, 550° C.) | | | | |
| Hardness | Shore A 7 days | >95 | >95 | >95 | >95 |
| devel- | Shore D 7 days | 61 | 60 | 59 | 65 |
| opment | | | | | |

Table 5 shows that the compositions prepared without a catalyst provide a time to failure in the range of 40-65 minutes, which is far below the time to failure obtained by the claimed intumescent coating composition.

TABLE 6
Comparative formulations with organic resin only

| | | E | F | G | H |
|---|---|---|---|---|---|
| | | comp. | comp. | comp. | comp. |
| Binder | Epoxy polysiloxane I | — | — | — | — |
| | Epoxy polysiloxane II | — | — | — | — |
| | Amine polysiloxane I | — | — | — | — |
| | Amine polysiloxane II | — | — | — | — |
| | Amine polysiloxane III | — | — | — | — |
| | Organic (epoxy) resin | 28.0 | 42.9 | 27.8 | 42.5 |
| | Epoxy curing agent | 13.4 | — | 13.3 | — |
| Catalyst | Catalyst I | 3.1 | 3.2 | 4.6 | 4.7 |
| | Catalyst II | — | — | — | — |
| | Catalyst III | 1.5 | 1.6 | — | — |
| Intu- | Acid generating | 20.3 | 19.6 | 20.4 | 19.8 |
| mescent | compound | | | | |
| package | Expansion agent | 6.8 | 6.5 | 6.8 | 6.6 |
| | Carbon donor | 13.5 | 13.1 | 13.6 | 13.2 |
| | compound | | | | |
| Pigment | Titanium dioxide | 13.5 | 13.1 | 13.6 | 13.2 |
| | Stoichiometry | 100 | 0 | 100 | 0 |
| | wt % organic resin | 100 | 100 | 100 | 100 |
| | Furnace C-TTF | 64 | 52 | 59 | 46 |
| | (Average, 550° C.) | | | | |
| Hardness | Shore D 7 days | 87 | 88 | 85 | 84 |
| devel- | | | | | |
| opment | | | | | |

Table 6 shows that the compositions based on a purely organic (epoxy) binder system provide a time to failure in the range of 40-65 minutes-, i.e. far below the time to failure obtained by the claimed intumescent coating composition.

1-20. (canceled)

21. An intumescent coating composition comprising
a) a polysiloxane-based binder system comprising
i) one or more epoxy-functional polysiloxane; and
b) one or more catalyst,
wherein said i) one or more epoxy-functional polysiloxane is represented by formula (I) below having a molecular weight in the range of 200 to 500,000 g/mol: 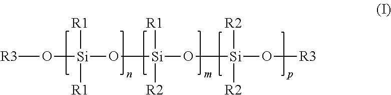
wherein n+m+p is an integer from 2 to 7500; and
wherein each R1 is individually selected from linear or branched C₁-C₃₀ alkyl, linear or branched C₂-C₃₀ alkenyl, C₃-C₃₀ cycloalkyl and aryl; and
wherein each R2 is individually selected from linear or branched C₁-C₃₀ alkyl, linear or branched C₂-C₃₀ alkenyl, C₃-C₃₀ cycloalkyl and aryl, substituted with at least one epoxy-functional group; and
wherein each R3 is individually selected from Si(R1)₃ and Si(R1)₂R2 and Si(R1) (R2)₂ and Si(R2)₃;
with the proviso that said epoxy-functional polysiloxane has at least one epoxy-functional group, and
wherein said b) one or more catalyst is suitable for catalyzing epoxy-epoxy reactions, amine-epoxy reactions, or epoxy-epoxy and amine-epoxy reactions and is an organic catalyst.

22. The intumescent coating composition according to claim 21, wherein said
a) polysiloxane-based binder system further comprises
ii) one or more amino-functional polysiloxane.

23. The intumescent coating composition according to claim 21, wherein said epoxy-functional polysiloxane has at least two epoxy-functional groups.

24. The intumescent coating composition according to claim 21, further comprising:
c) an intumescent package, wherein said c) intumescent package comprises a group of compounds comprising one or more first compound comprising an acid generating compound, optionally one or more second compound comprising an expansion agent and optionally one or more further compound comprising a carbon donor compound.

25. The intumescent coating composition according to claim 21, wherein said binder system comprises more than 50 wt % of polysiloxanes.

26. The intumescent coating composition according to claim 22, wherein the stoichiometry between active hydrogens on the amino-functional polysiloxane relative to epoxy groups on the epoxy-functional polysiloxane is at least 5%.

27. The intumescent coating composition according to claim 21, wherein said epoxy-functional group is selected from the list of formulas below

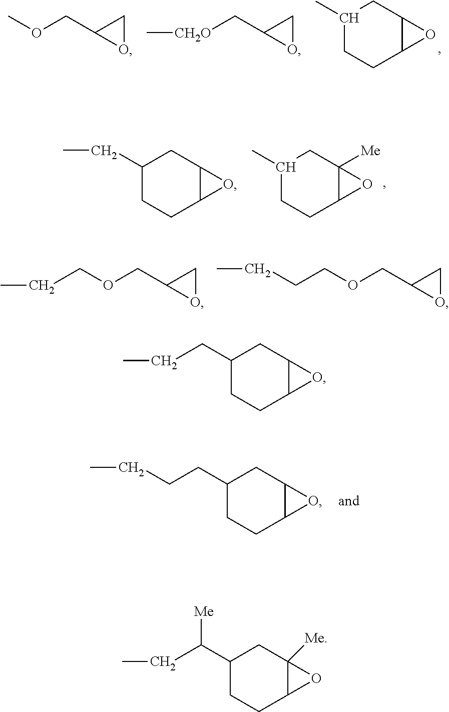

28. The intumescent coating composition according to claim 22, wherein said one or more amino-functional polysiloxane is represented by formula (II) below having a molecular weight in the range of 200 to 500,000 g/mol: 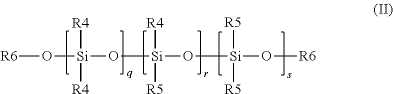
wherein q+r+s is an integer from 2 to 7500; and
wherein each R4 is individually selected from linear or branched C₁-C₃₀ alkyl, linear or branched C₂-C₃₀ alkenyl, C₃-C₃₀ cycloalkyl and aryl; and
wherein each R5 is individually selected from linear or branched C₁-C₃₀ alkyl, linear or branched C₂-C₃₀ alkenyl, C₃-C₃₀ cycloalkyl and aryl, and substituted with at least one amino-functional group; and
wherein each R6 is individually selected from Si(R4)₃ and Si(R4)₂R5 and SiR4(R5)₂ and Si(R5)₃;
with the proviso that said amino-functional polysiloxane has at least one primary amino-functional group, or at least two secondary amino-functional groups, or at least one primary and at least one secondary amino-functional group.

29. The intumescent coating composition according to claim 21, wherein, if any organic resin is present in the binder system, said organic resin is present in an amount below 50%.

30. The intumescent coating composition according to claim 21, wherein said one or more catalyst b) comprises a catalyst selected from a tertiary amine such as 2,4,6-tris(dimethylaminomethyl)phenol or a phenol derivative such as fluorophenol or nitrophenol; or combinations thereof.

31. The intumescent coating composition according to claim 21, wherein said one or more catalyst b) is present in a total amount of between 0.1-10.0%.

32. The intumescent coating composition according to claim 24, wherein said c)-intumescent package comprises one or more first compound being an acid generating compound.

33. The intumescent coating composition according to claim 34, wherein said c) intumescent package comprises one or more second compound being an expansion agent.

34. The intumescent coating composition according to claim 34, wherein said c) intumescent package further comprises one or more further compound being a carbon donor compound.

35. A kit of parts, suitable for the formulation of an intumescent coating composition comprising a polysiloxane-based binder system, wherein said kit comprises:
A1) a container containing one or more epoxy-functional polysiloxane as described according to claim 21; and
B) a container containing one or more catalyst.

36. A kit of parts, suitable for the formulation of an intumescent coating composition comprising a polysiloxane-based binder system, wherein said kit comprises:
A1) a container containing one or more epoxy-functional polysiloxane as described according to claims 21; and
A2) a container containing one or more amino-functional polysiloxane; and
wherein
said container A1) further contains one or more catalyst, and/or
said container A2) further contains one or more, and/or
said kit further comprises B) a container containing one or more catalyst.

37. Use of a coating composition according to claim 21 for application on the surface of a substrate such as on a metal substrate or a metal alloy substrate.

38. A substrate, such as a steel substrate, having on at least a part of the surface, a coat obtained from a coating composition according to claim 21.
